(19) United States
(12) Patent Application Publication
(10) Pub. No.: US 2022/0264194 A1
(43) Pub. Date: Aug. 18, 2022

(54) ALARM VERIFICATION SYSTEM FOR ELECTRONICS CABINET

(71) Applicant: COMMSCOPE TECHNOLOGIES LLC, Hickory, NC (US)

(72) Inventors: Steven Zanft, Milan, Italy (GB); David Streets, Scarborough (GB)

(21) Appl. No.: 17/597,901

(22) PCT Filed: Aug. 4, 2020
(86) PCT No.: PCT/US2020/044877

§ 371 Date: Jan. 28, 2022

Related U.S. Application Data
(60) Provisional application No. 62/884,233, filed on Aug. 8, 2019.

(51) Int. Cl. H04Q 1/02

(52) U.S. Cl. CPC H04Q 1/025

(57) ABSTRACT

A system includes an alarm processing module that is configured to receive a plurality of alarm signals that are generated based on conditions associated with an electronics cabinet. Each of the plurality of alarm signals has an alarm state and an ambient state associated therewith. The alarm processing module is further configured to generate an alarm notification signal in response to at least one of the plurality of alarm signals being in the alarm state.

### RELATED APPLICATION

The present application claims priority from and the benefit of U.S. Provisional Patent Application No. 62/884,233, filed Aug. 8, 2019, the disclosure of which is hereby incorporated herein in its entirety.

### FIELD OF THE INVENTION

The present invention relates generally to cabinets, and more specifically to electronics cabinets.

### BACKGROUND

Outdoor electronic cabinets have become popular in recent years. They can protect a wide range of electronic equipment including radios, multicarrier power amplifiers (MCPA), power supplies, batteries, and wireless cell site backhaul equipment. These cabinets can protect base station equipment from environmental conditions while reducing operating expenses and energy consumption.

Because electronics cabinets house equipment that generates heat during operation, cabinets often include cooling or thermal management systems (TMSs) to reduce the risk of the equipment overheating. The thermal management systems may generate alarms or alerts when conditions in the cabinet may damage the electronic equipment stored therein, e.g., when a temperature inside the cabinet and/or inside one or more pieces of equipment exceeds a threshold, when a piece of cooling equipment becomes inoperable, or the like. FIG. 1 is a circuit schematic of a thermal management system used in some electronics cabinets. As shown in FIG. 1, the thermal management system circuit 100 includes a TMS alarm module 105 that is configured to generate major and/or minor alarm signals in response to thermal events, e.g., a temperature exceeding a threshold, a cooling system becoming inoperable, or the like. The major alarm signal may be asserted in response to more critical thermal events, such as a cooling system ceasing operation, and a minor alarm signal may be asserted in response to less critical events, such as a temperature rising above a pre-defined threshold. The thermal management system circuit 100 is configured to generate a major and/or minor alarm signal at the output terminals “MA” and/or “MI,” respectively, at a common or ground voltage level in an ambient state when the alarm condition is not satisfied. That is, the TMS alarm module 105 is configured to close the relay or switch 110 in the ambient state such that the output terminal “MA” and/or output terminal “MI” is shorted to the common or reference terminal “C.” In response to a major thermal event that satisfies the alarm condition, the TMS alarm module 105 is configured to open the switch 110 to generate the major alarm output signal at the output terminal “MA” so as to have a non-zero magnitude (e.g., at about a power system voltage level and/or a voltage level corresponding to a logical one). In response to a minor thermal event that satisfies the alarm condition, the TMS alarm module 105 is configured to open the switch 111 to generate the minor alarm output signal at the output terminal “MI” so as to have a non-zero magnitude. The multiple pieces of electronic equipment residing in the electronics cabinet may each have their own thermal management system associated therewith. Each of the thermal management modules may be configured to assert major and/or minor alarm output signals at a common or ground voltage level in an ambient state when the alarm condition is not satisfied and to assert the major and/or minor alarm output signals so as to have a non-zero magnitude (e.g., at about a power system voltage level and/or a voltage level corresponding to a logical one) when the alarm condition is satisfied.

FIG. 2 is a circuit schematic of how multiple thermal management systems used in some electronics cabinets may be connected in parallel. As shown in FIG. 2, the multi-thermal management system 200 includes three TMS alarm modules 205a, 205b, and 205c connected in parallel. The three TMS alarm modules 205a, 205b, and 205c, are configured to operate relays or switches 210a, 210b, and 210c, respectively, so that the respective switch 210a, 210b, and 210c is closed in an ambient state and open in response to a major thermal event, and are further configured to operate relays or switches 211a, 211b, and 211c, respectively, so that the respective switch 211a, 211b, and 211c is closed in an ambient state and open in response to a minor thermal event. As shown in FIG. 2, TMS alarm modules 205a and 205c have opened the switches 210a and 210c to assert a major alarm condition for the equipment and/or interior of the electronics cabinet associated with the respective TMS alarm modules 205a and 205c. The TMS alarm module 205b, however, is in the ambient state with respect to a major alarm condition, i.e., a major alarm condition is not satisfied, which results in the switch 210b remaining closed. This results in the major alarm conditions associated with the TMS alarm modules 205a and 205c being masked as the switch 210b shorts the output terminal “MA” to the common or reference terminal “C.” Similarly, TMS alarm module 205b has opened the switch 211b to assert a minor alarm for the equipment and/or interior of the electronics cabinet associated with the TMS alarm module 205b. The TMS alarm modules 205a and 205c, however, are in the ambient states with respect to a minor alarm condition, i.e., a minor alarm condition is not satisfied, which results in the switches 211a and 211c remaining closed. This results in the minor alarm condition associated with the TMS alarm module 205b being masked as the switches 211a and 211c shorts the output terminal “MI” to the common or reference terminal “C.” It may, therefore, not be desirable to couple multiple thermal management systems in parallel as any alarm system in the ambient state will mask all other alarm systems that are asserting an alarm condition.

### SUMMARY

According to some embodiments of the inventive concept, a system comprises an alarm processing module that is configured to receive a plurality of alarm signals that are generated based on conditions associated with an electronics cabinet, each of the plurality of alarm signals having an alarm state and an ambient state associated therewith, the alarm processing module being further configured to generate an alarm notification signal in response to at least one of the plurality of alarm signals being in the alarm state.

In other embodiments, the plurality of alarm signals is associated with a plurality of environmental management modules, respectively.

In still other embodiments, the plurality of environmental management modules comprises a plurality of thermal management modules, respectively.

In still other embodiments, the plurality of environmental management modules comprises a plurality of humidity management modules, respectively.

In still other embodiments, the electronics cabinet comprises an enclosure and further comprises a door for accessing the enclosure, the door having an open and a closed state. The plurality of environmental management modules comprises a door state management module that is configured to detect whether the door is in the open or the closed state.

In still other embodiments, the plurality of environmental management modules further comprises a plurality of thermal management modules.

In still other embodiments, the plurality of environmental management modules further comprises a plurality of humidity management modules.

In still other embodiments, the electronics cabinet comprises an enclosure and the plurality of alarm signals are generated inside the enclosure. The system further comprising an alarm notification output module coupled to the alarm processing module and configured for mounting outside of the enclosure, the alarm notification output module being further configured to output the alarm notification signal.

In still other embodiments, the plurality of alarm signals comprises a plurality of major alarm signals and a plurality of minor alarm signals, the alarm processing module is further configured to generate a major alarm notification signal in response to at least one of the plurality of major alarm signals being in the alarm state, the alarm processing module is further configured to generate a minor alarm notification signal in response to at least one of the plurality of minor alarm signals being in the alarm state, and the alarm notification output module is further configured to output the major alarm notification signal and to output the minor alarm notification signal.

In still other embodiments, the electronics cabinet comprises an enclosure, the enclosure being configured to receive a plurality of electrical equipment modules therein.

In still other embodiments, the plurality of electrical equipment modules comprises a power supply, a backup power supply, a cooling fan, a Radio Frequency (RF) transceiver, and a data interface module.

In still other embodiments, the electronics cabinet is one of a plurality of electronics cabinets, each of the plurality of electronics cabinets comprising an enclosure. The plurality of alarm signals are generated inside the enclosures of at least two of the plurality of electronics cabinets.

In still other embodiments, the alarm processing module comprises at least one discrete logic element configured to generate the alarm notification signal in response to the plurality of alarm signals.

In still other embodiments, the alarm processing module comprises a processor and a memory coupled to the processor and comprising computer readable program code embodied in the memory that is executable by the processor to generate the alarm notification signal in response to the plurality of alarm signals.

In some embodiments of the inventive concept, a method comprises receiving a plurality of alarm signals that are generated based on conditions associated with an electronics cabinet at an alarm processing module, each of the plurality of alarm signals having an alarm state and an ambient state associated therewith, and generating an alarm notification signal using the alarm processing module in response to at least one of the plurality of alarm signals being in the alarm state.

In further embodiments, the plurality of alarm signals is associated with a plurality of environmental management modules, respectively.

In still further embodiments, the plurality of environmental management modules comprises a plurality of thermal management modules, respectively.

In still further embodiments, the plurality of environmental management modules comprises a plurality of humidity management modules, respectively.

In still further embodiments, the electronics cabinet comprises an enclosure and further comprises a door for accessing the enclosure, the door having an open and a closed state. The plurality of environmental management modules comprises a door state management module that is configured to detect whether the door is in the open or the closed state.

In still further embodiments, the plurality of environmental management modules further comprises a plurality of thermal management modules.

In still further embodiments, the plurality of environmental management modules further comprises a plurality of humidity management modules.

In still further embodiments, the electronics cabinet comprises an enclosure. The plurality of alarm signals are generated inside the enclosure and the method further comprises outputting the alarm notification signal using an alarm notification output module that is coupled to the alarm processing module and is mounted outside of the enclosure.

In still further embodiments, the plurality of alarm signals comprises a plurality of major alarm signals and a plurality of minor alarm signals. The method further comprising: generating a major alarm notification signal in response to at least one of the plurality of major alarm signals being in the alarm state using the alarm processing module, generating a minor alarm notification signal in response to at least one of the plurality of minor alarm signals being in the alarm state using the alarm processing module, and outputting the major alarm notification signal and the minor alarm notification signal using the alarm notification output module.

Other methods, systems, articles of manufacture, and/or computer program products according to embodiments of the inventive concept will be or become apparent to one with skill in the art upon review of the following drawings and detailed description. It is intended that all such additional systems, methods, articles of manufacture, and/or computer program products be included within this description, be within the scope of the present inventive concept, and be protected by the accompanying claims.

### BRIEF DESCRIPTION OF THE DRAWINGS

FIG. 1 is a circuit schematic of a thermal management system used in some electronics cabinets;

FIG. 2 is a circuit schematic of multiple thermal management systems used in some electronics cabinets connected in parallel;

FIG. 3 is an elevation view that illustrates an electronics cabinet system according to some embodiments of the inventive concept;

FIG. 4 is a block diagram that illustrates contents of an electronics cabinet according to some embodiments of the inventive concept;

FIG. 5 is a block diagram that illustrates an alarm processing system according to some embodiments of the inventive concept;

FIG. 6 is a circuit schematic of an alarm processing system according to some embodiments of the inventive concept;

FIG. 7 is a block diagram of a data processing system that may be used in an alarm processing system according to some embodiments of the inventive concept; and

FIG. 8 is a block diagram that illustrates a hardware/software architecture for processing alarms according to some embodiments of the inventive concept.

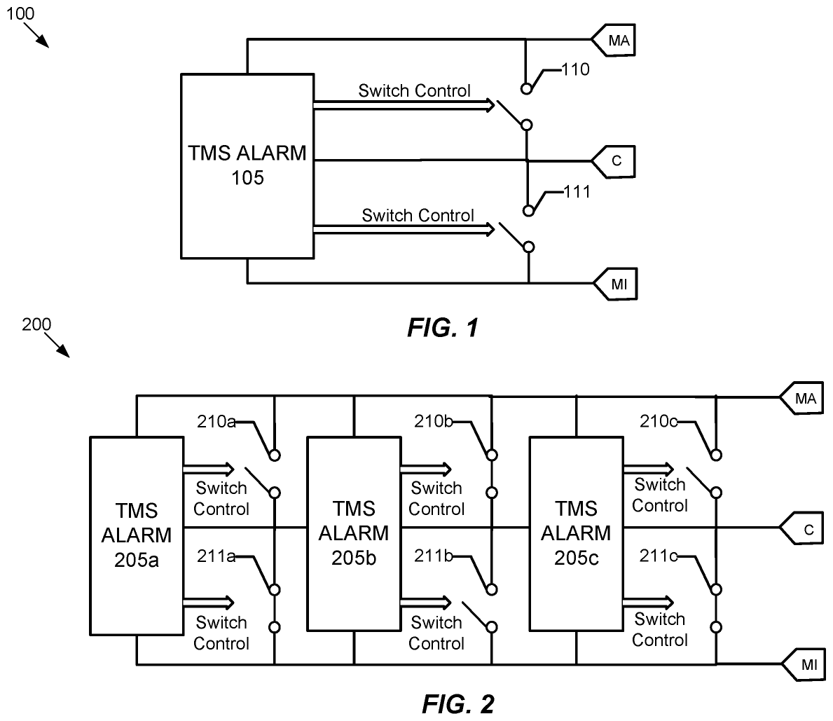

### DETAILED DESCRIPTION

In the following detailed description, numerous specific details are set forth to provide a thorough understanding of embodiments of the present disclosure. However, it will be understood by those skilled in the art that the present invention may be practiced without these specific details. In some instances, well-known methods, procedures, components and circuits have not been described in detail so as not to obscure the present disclosure. Aspects described with respect to one embodiment may be incorporated in different embodiments although not specifically described relative thereto. That is, all embodiments and/or features of any embodiments can be combined in any way and/or combination.

Electronics cabinets, such as those used, for example, at cellular base station towers and facilities, may use environmental management modules, such as thermal management systems, to generate alarms or alerts when conditions in the cabinet may damage the electronic equipment stored therein. For example, thermal management systems may trigger an alarm in response to various types of events, such as when the temperature inside the electronics cabinet exceeds a threshold, when a cooling fan stops operating, when there is a loss in power, etc. For some cabinets, it may be desirable to incorporate multiple environmental management modules. The multiple pieces of electronic equipment residing in the electronics cabinet may each have their own thermal management system associated therewith. In addition, there may be additional environmental management modules that may generate alarms based on, for example, the humidity level, a state of a door (e.g., open or closed) used for accessing the electronics cabinet, the presence of corrosive agents, dust, insects, contaminants, and the like. Each of the environmental management modules may, in some embodiments, be configured to generate an alarm output signal at a common or ground voltage level in an ambient state when the alarm condition is not satisfied and to generate the alarm output signal so as to have a non-zero magnitude (e.g., at about a power system voltage level and/or a voltage level corresponding to a logical one) when the alarm condition is satisfied. Some embodiments of the inventive concept stem from a realization that multiple ones of these environmental management modules cannot be configured in parallel as the assertion of an alarm condition (i.e., driving an output to non-zero voltage level and/or a logical one voltage level) by one of the environmental management modules would be shorted to a common or ground voltage level by other one(s) of the environmental management modules for which an alarm condition is not satisfied and are in an ambient state. Any environmental management module that is in an ambient state may mask any other environmental management modules asserting an alarm condition when the environmental management modules are electrically coupled in parallel. Some embodiments of the inventive concept provide an alarm processing module that is configured to receive a plurality of alarm signals that are generated based on conditions associated with the electronics cabinet. Each of the alarm signals has an alarm state and an ambient state associated therewith. The alarm processing module may be configured to generate an alarm notification in response to one or more of the alarm signals being in the alarm state. The alarm processing module may be implemented in a variety of ways in accordance with different embodiments of the inventive concept. For example, in some embodiments, the alarm processing module may be implemented using logic gates, such as inverters and multiple input NAND gates for receiving the alarm signals at input terminals thereof. In other embodiments, the alarm processing module may be implemented using a programmable microcontroller or other programmable data processing system.

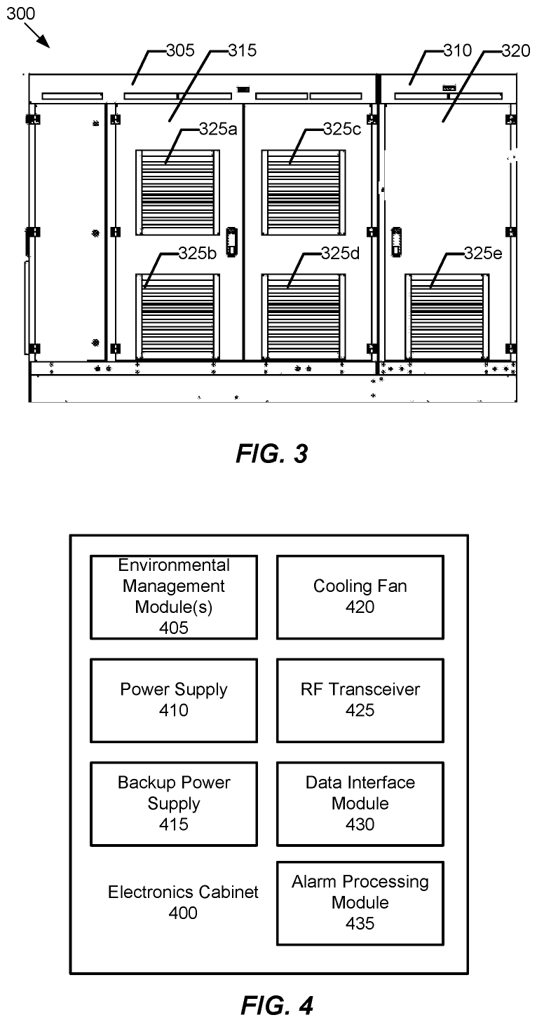

Referring now to FIG. 3, an electronics cabinet system 300, according to some embodiments of the inventive concept, includes two electronics cabinets 305 and 310. Each of the electronics cabinets 305 and 310 is generally box-shaped, with a front wall, opposed side walls, a rear wall, a ceiling, and a floor. Electronics cabinet 305 includes a double-door 315 and electronics cabinet 310 includes a single door 320. The double-door 315 may serve as the front wall of the electronics cabinet 305 and the single door 320 may serve as the front wall of the electronics cabinet 310. The doors 315 and 320 of the electronics cabinet 305 may include vents 325a, 325b, 325c, 325d, and 325e as shown. The electronics cabinet system 300 may be of conventional construction and need not be described in detail herein. The front wall is typically positioned between about 18 and 28 inches from the rear wall. Each of the electronics cabinets 305 and 310 is typically between about 60 and 84 inches in height.

Support rails along with mounting brackets may be mounted on the interior side and back walls of each of the electronics cabinets 305 and 310 for supporting various types of electronics equipment. The mounting brackets may be adjustable, for example, between about 19″ and about 23″ for receiving electronics equipment of various widths.

FIG. 4 is a block diagram that illustrates contents of an electronics cabinet according to some embodiments of the inventive concept. As shown in FIG. 4, an electronics cabinet 400 may be representative of electronics cabinets 305 and/or 310 described above with respect to FIG. 3. Example equipment that may be mounted inside the electronics cabinet 400 in a cellular base station application may include, but is not limited to, environmental management module(s) 405, a power supply 410, a backup power supply 415, a cooling fan 420, an RF transceiver 425, a data interface module 430 to mediate between the RF transceiver 425 and a wireline network, and an alarm processing module 435. It will be understood that other types of equipment may also be installed in the electronics cabinet 400 including, for example, fiber management components, routers, microwave radios, digital security units, control systems, optical test units, and the like. It will be further understood that the contents of the electronics cabinet 400 will vary based on application. That is, the contents of the electronics cabinet 400 in a cellular base station application may be different from the contents of an electronics cabinet 400 in a power distribution network, a server farm, or other application.

The environmental management module(s) 405 may represent various monitoring or management modules for the electronics cabinet 400 and/or the electronics equipment therein. The environmental management module(s) 405 may each generate one or more alarm signals based on conditions associated with the electronics cabinet 400 and/or the equipment contained therein. These modules may include, but are not limited to, one or more thermal management modules that protect against overheating, one or more humidity management modules to monitor the relative humidity proximate to specific pieces of equipment or in the cabinet generally, one or more particulate matter detection modules to detect dust or other particulate matter that may infiltrate a cabinet, one or more filter expiration modules that may provide a reminder of when to change an air filter based on age and/or evaluation of the effectiveness of the filter, one or more motion detector modules that may detect intrusions by pests, such as insets, rodents, and the like that may do damage to electronic equipment, cabling, and/or wiring, and one or more door state management modules, which may be used to detect whether a door to the cabinet is in an open or closed state. A thermal management module may be configured to monitor conditions generally within a cabinet, such as temperature, the operability of a cooling system, such as a cooling fan 420, the operability of a power supply 410, the operability of a backup power supply 415, and the like or a thermal management module may be configured to monitor the conditions of one or more specific pieces of electrical equipment including, for example, temperature, power status, cooling apparatus status, and the like. Thus, a cabinet may have one or more thermal management modules installed therein. Thermal management modules may also be configured to generate both major and minor alarms. For example, conditions that require immediate attention by support personnel, such as a cooling fan failure, power system failures, and the like may result in a major alarm. A relatively minor overheating event may result in a minor alarm indicating that the problem should be given attention, but it does not rise to the level of adversely affecting immediate operation of the associated or affected equipment.

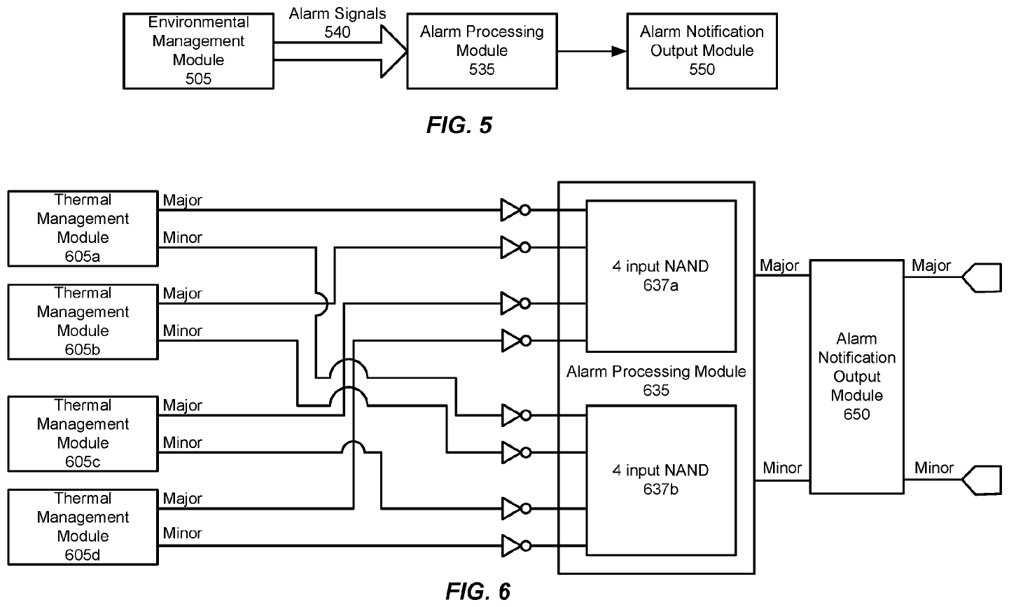

FIG. 5 is a block diagram that illustrates an alarm processing system according to some embodiments of the inventive concept. The alarm processing module 535 may be configured to receive alarm signals 540 generated by the environmental management module(s) 505 based on conditions associated with the electronics cabinet 400 and/or the electronics equipment contained therein. The alarm processing module 535 may process multiple alarms from multiple environmental management modules 505 without the problem described above with respect to FIG. 2 of one alarm being in an ambient state masking one or more other alarms that are in the alarm state asserting an alarm condition. The alarm processing module 535 may be configured to process multiple alarm signals and generate an alarm notification signal based on these multiple alarm signals that can then be output to an alarm notification output module 550, such as, for example, an insulation displacement connector block that can be mounted, for example, on the outside of the electronics cabinet 400. The alarm processing module 535 may, in some embodiments, receive alarm signals from environmental management modules 505 spread across multiple electronics cabinets. For example, an alarm processing module 535 may receive alarm signals generated from environmental management modules 505 that monitor alarm conditions in both electronics cabinet 305 and electronics cabinet 310 of electronics cabinet system 300.

FIG. 6 is a circuit schematic of an alarm processing system according to some embodiments of the inventive concept. In the example of FIG. 6, one or more electronics cabinets having multiple thermal management modules are illustrated. Although thermal management modules are used in FIG. 6 for purposes of illustrating embodiments of the inventive concept, it will be understood that other types of environmental management modules can be used in similar fashion. Referring now to FIG. 6, four thermal management modules 605a, 605b, 605c, and 605d may be installed across one or more electronics cabinets, such as electronics cabinets 305, 310, and 400 described above. The thermal management modules 605a, 605b, 605c, and 605d may each be configured to generate major and minor alarms based on conditions associated with the electronics cabinet 305, 310, and 400 and/or one or more pieces of electronics equipment contained therein. An alarm processing module 635 is configured to receive the major and minor alarm signals generated by the thermal management modules 605a, 605b, 605c, and 605d. The alarm processing module 635 may be configured to provide Boolean logic “OR” functionality, such that an output is asserted if one or more of the inputs is asserted. For example, if one or more of the major alarms from a thermal management module 605a, 605b, 605c, or 605d is asserted with a logical high value, then the major alarm output of the alarm processing module 635 may likewise be driven to a high logical value. Similarly, if one or more of the minor alarms from a thermal management module 605a, 605b, 605c, or 605d is asserted with a logical high value, then the minor alarm output of the alarm processing module 635 may likewise be driven to a high logical value. In the example shown, the alarm processing module 635 includes a first four-input NAND gate 637a for processing the major alarm signals generated by the thermal management modules 605a, 605b, 605c, and 605d and a second four-input NAND gate 637b for processing the minor alarm signals generated by the thermal management modules 605a, 605b, 605c, and 605d. The major and minor alarm signals generated by the thermal management modules 605a, 605b, 605c, and 605d are inverted prior to input to the four-input NAND gates 637a and 637b. A four-input NAND gate will generate a logical high output unless all four inputs are at logical high levels. For thermal management modules that assert an alarm condition with a logical high value and an ambient condition or state with a logical low value, inverters are used in front of the input to the NAND gates 637a and 637b so that if an alarm signal generated by any of the thermal management modules 605a, 605b, 605c, and 605d is in the alarm state (i.e., logical high value), then the alarm processing module 635 by way of the four-input NAND gates 637a, 637b will generate an alarm notification signal for the alarm notification output module 650 at a logical high value.

In the example shown in FIG. 6, the four major alarm signals generated by the thermal management modules 605a, 605b, 605c, and 605d are inverted and provided as inputs to the four-input NAND gate 637a and the four minor alarm signals generated by the thermal management modules 605a, 605b, 605c, and 605d are inverted and provided as inputs to the four-input NAND gate 637b. If any of the major alarm signals are driven high into the alarm state due to detection of a major thermal alarm condition, then the major output of the four-input NAND gate 637a will be driven to a high logical value and provided to the alarm notification output module 650. If any of the minor alarm signals are driven high into the alarm state due to detection of a minor thermal alarm condition, then the minor output of the four-input NAND gate 637b will be driven to a high logical value and provided to the alarm notification output module 650. Thus, as long as any one of the thermal management modules 605a, 605b, 605c, and 605d is asserting a major alarm signal in the alarm state, the alarm processing module 635 will assert a major alarm notification signal as an output to be provided to the alarm notification output module 650 irrespective of the major alarm signal states of other ones of the thermal management modules. The same principle applies equally to the minor alarm signals generated by the thermal management modules 605a, 605b, 605c, and 605d. Thus, unasserted or ambient state alarm signals of the thermal management modules 605a, 605b, 605c, and 605d do not mask asserted or alarm state alarm signals of the thermal management modules 605a, 605b, 605c, and 605d, such as that described above with respect to FIG. 2.

The alarm notification output module 650 may, in some embodiments, be an insulation displacement connector that is provided on the outside of an electronics cabinet to provide access to the alarm notification signal(s) generated by the alarm processing module 635. This may allow support personnel to visually inspect an electronics cabinet for alarms without the need to open any doors to look inside.

FIG. 6 illustrates the alarm processing module 635 as being implemented using discrete logic gates, e.g., four-input NAND gates in conjunction with inverters in accordance with some embodiments of the inventive concept. In other embodiments, the alarm processing module 635 may be implemented using a programmable data processing system, microcontroller, or the like for implementing the logic used for processing alarm signals generated by one or more environmental management modules associated with one or more electronics cabinets. Moreover, different types of logic gates may be used to implement the Boolean “OR” functionality, including an “OR” gate or other combinations of logic gates. A NAND gate is functionally complete or a universal gate in that it can be used to implement any other Boolean logic gates. As a result, many logical circuits are designed using a combination of NAND gates. Different Boolean logic may also be used depending on whether the state of an alarm signal output from an environmental management module 505 is logical high or logical low to represent an asserted alarm.

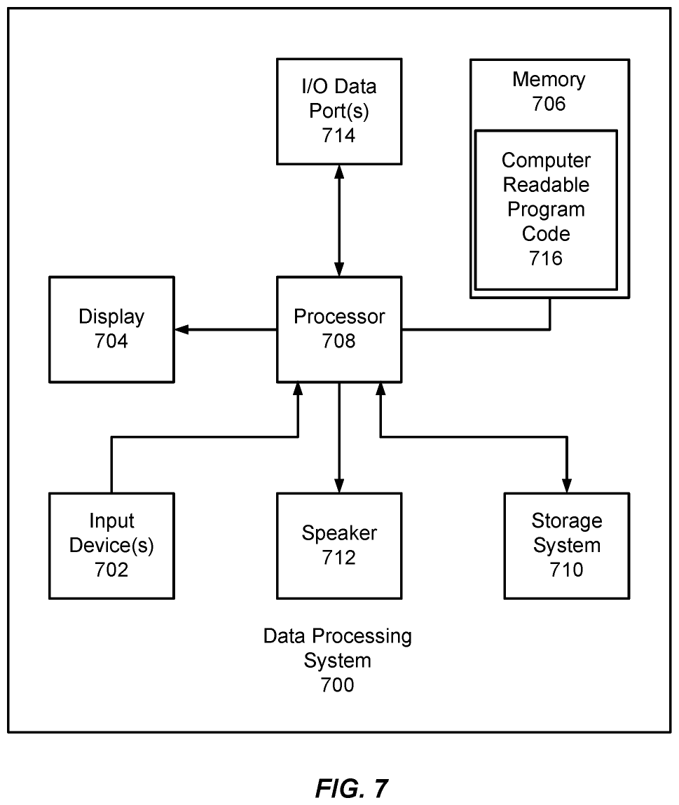

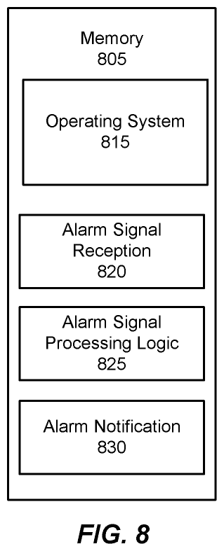

Referring now to FIG. 7, a data processing system 700 that may be used to implement the alarm processing module 435, 535, 635, in accordance with some embodiments of the inventive concept, comprises input device(s) 702, such as a keyboard or keypad, a display 704, and a memory 706 that communicate with a processor 708. The data processing system 700 may further include a storage system 710, a speaker 712, and an input/output (I/O) data port(s) 714 that also communicate with the processor 708. The processor 708 may be, for example, a commercially available or custom microprocessor. The storage system 710 may include removable and/or fixed media, such as floppy disks, ZIP drives, hard disks, or the like, as well as virtual storage, such as a RAMDISK. The I/O data port(s) 714 may be used to transfer information between the data processing system 700 and another computer system or a network (e.g., the Internet). These components may be conventional components, such as those used in many conventional computing devices, and their functionality, with respect to conventional operations, is generally known to those skilled in the art. The memory 706 may be configured with computer readable program code 716 to facilitate processing of alarm signals that are generated based on conditions associated with an electronics cabinet in accordance with some embodiments of the inventive concept. It will be understood that more or fewer components may be used in the data processing system depending on whether the data processing system is implemented as an embedded microcontroller, for example, or a computer configured for user interaction.

FIG. 8 illustrates a memory 805 that may be used in embodiments of data processing systems, such as the alarm processing module 435, 535, 635 and the data processing system of FIG. 7, respectively, to facilitate processing of alarm signals that are generated based on conditions associated with an electronics cabinet in accordance with some embodiments of the inventive concept. The memory 805 is representative of the one or more memory devices containing the software and data used for facilitating operations of the alarm processing module 435, 535, 635 as described herein. The memory 805 may include, but is not limited to, the following types of devices: cache, ROM, PROM, EPROM, EEPROM, flash, SRAM, and DRAM.

As shown in FIG. 8, the memory 805 may contain four or more categories of software and/or data: an operating system 815, an alarm signal reception module 820, an alarm signal processing logic module 825, and an alarm notification module 830. In particular, the operating system 815 may manage the data processing system's software and/or hardware resources and may coordinate execution of programs by the processor. The alarm signal reception module may be configured to receive one or more alarm signals from environmental management modules 405 associated with one or more electronics cabinets. The alarm signal processing logic module 825 may be configured to process the alarm signals from the environmental management modules 405 and to generate or assert an output signal, e.g., an alarm notification signal, which indicates at least one of the alarm signals is in the alarm state. The alarm notification module 830 may provide the alarm notification signal to an alarm notification output module 650, which may be mounted externally to the electronics cabinet to facilitate reviewing the alarm state of the environmental management modules 405 without the need to access the enclosed area of the electronics cabinet.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, LabVIEW, dynamic programming languages, such as Python, Ruby and Groovy, or other programming languages.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

It will be understood that, although the terms “first,” “second,” etc. may be used herein to describe various elements, these elements should not be limited by these terms. These terms are only used to distinguish one element from another. Thus, a first element could be termed a second element without departing from the teachings of the inventive subject matter.

It will be understood that when an element is referred to as being “on”, “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described to best explain the principles of the disclosure and the practical application, and to enable others of ordinary skill in the art to understand the disclosure with various modifications as are suited to the particular use contemplated.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1.-23. (canceled)

24. A system, comprising:
an alarm processing module that is configured to receive a plurality of alarm signals that are generated based on conditions associated with an electronics cabinet, each of the plurality of alarm signals having an alarm state and an ambient state associated therewith, the alarm processing module being further configured to generate an alarm notification signal in response to at least one of the plurality of alarm signals being in the alarm state.

25. The system of claim 24, wherein the plurality of alarm signals is associated with a plurality of environmental management modules, respectively.

26. The system of claim 25, wherein the plurality of environmental management modules comprises a plurality of thermal management modules, respectively.

27. The system of claim 25, wherein the plurality of environmental management modules comprises a plurality of humidity management modules, respectively.

28. The system of claim 25, wherein the electronics cabinet comprises an enclosure and further comprises a door for accessing the enclosure, the door having an open and a closed state; and
wherein the plurality of environmental management modules comprises:
a door state management module that is configured to detect whether the door is in the open or the closed state;
a plurality of thermal management modules; and
a plurality of humidity management modules.

29. The system of claim 24, wherein the electronics cabinet comprises an enclosure;
wherein the plurality of alarm signals are generated inside the enclosure; and wherein the system further comprises:
an alarm notification output module coupled to the alarm processing module and configured for mounting outside of the enclosure, the alarm notification output module being further configured to output the alarm notification signal.

30. The system of claim 29, wherein the plurality of alarm signals comprises a plurality of major alarm signals and a plurality of minor alarm signals;
wherein the alarm processing module is further configured to generate a major alarm notification signal in response to at least one of the plurality of major alarm signals being in the alarm state;
wherein the alarm processing module is further configured to generate a minor alarm notification signal in response to at least one of the plurality of minor alarm signals being in the alarm state; and
wherein the alarm notification output module is further configured to output the major alarm notification signal and to output the minor alarm notification signal.

31. The system of claim 24, wherein the electronics cabinet comprises an enclosure, the enclosure being configured to receive a plurality of electrical equipment modules therein;
wherein the plurality of electrical equipment modules comprises a power supply, a backup power supply, a cooling fan, a Radio Frequency (RF) transceiver, and a data interface module.

32. The system of claim 24, wherein the electronics cabinet is one of a plurality of electronics cabinets, each of the plurality of electronics cabinets comprising an enclosure; and
wherein the plurality of alarm signals are generated inside the enclosures of at least two of the plurality of electronics cabinets.

33. The system of claim 24, wherein the alarm processing module comprises at least one discrete logic element configured to generate the alarm notification signal in response to the plurality of alarm signals.

34. The system of claim 24, wherein the alarm processing module comprises:
a processor; and
a memory coupled to the processor and comprising computer readable program code embodied in the memory that is executable by the processor to generate the alarm notification signal in response to the plurality of alarm signals.

35. A method, comprising:
receiving a plurality of alarm signals that are generated based on conditions associated with an electronics cabinet at an alarm processing module, each of the plurality of alarm signals having an alarm state and an ambient state associated therewith; and
generating an alarm notification signal using the alarm processing module in response to at least one of the plurality of alarm signals being in the alarm state.

36. The method of claim 35, wherein the plurality of alarm signals is associated with a plurality of environmental management modules, respectively.

37. The method of claim 36, wherein the plurality of environmental management modules comprises a plurality of thermal management modules, respectively.

38. The method of claim 36, wherein the plurality of environmental management modules comprises a plurality of humidity management modules, respectively.

39. The method of claim 36, wherein the electronics cabinet comprises an enclosure and further comprises a door for accessing the enclosure, the door having an open and a closed state; and
wherein the plurality of environmental management modules comprises a door state management module that is configured to detect whether the door is in the open or the closed state.

40. The method of claim 39, wherein the plurality of environmental management modules further comprises a plurality of thermal management modules.

41. The method of claim 40, wherein the plurality of environmental management modules further comprises a plurality of humidity management modules.

42. The method of claim 35, wherein the electronics cabinet comprises an enclosure;
wherein the plurality of alarm signals are generated inside the enclosure; and wherein the method further comprises:
outputting the alarm notification signal using an alarm notification output module that is coupled to the alarm processing module and is mounted outside of the enclosure.

43. The method of claim 42, wherein the plurality of alarm signals comprises a plurality of major alarm signals and a plurality of minor alarm signals;
wherein the method further comprises:
generating a major alarm notification signal in response to at least one of the plurality of major alarm signals being in the alarm state using the alarm processing module;
generating a minor alarm notification signal in response to at least one of the plurality of minor alarm signals being in the alarm state using the alarm processing module; and
outputting the major alarm notification signal and the minor alarm notification signal using the alarm notification output module.
